(19) United States
(12) Patent Application Publication
(10) Pub. No.: US 2015/0308280 A1
(43) Pub. Date: Oct. 29, 2015

(54) ASSEMBLY FORMING A SEAL FOR A TURBOMACHINE INCLUDING A BRUSH SEAL AND AT LEAST ONE LIP

(71) Applicant: Snecma, Paris (FR)

(72) Inventors: Jean-Christophe DUFFET, Saint Mande (FR); Benoit Guillaume Farvacque, Paris (FR)

(73) Assignee: Snecma, Paris (FR)

(21) Appl. No.: 14/474,463

(22) Filed: Sep. 2, 2014

(30) Foreign Application Priority Data
Sep. 6, 2013 (FR) 13 58576

(51) Int. Cl. F01D 11/08; F16J 15/00; F16J 15/32; F01D 5/02

(52) U.S. Cl. CPC F01D 11/08; F01D 5/02; F16J 15/002; F16J 15/3204; F16J 15/3288; F05D 2220/30; F05D 2240/56

(57) ABSTRACT

The main object of the invention is an assembly forming a seal (1) for a turbomachine (10), used to provide a seal between two elements of the turbomachine (10) rotating relative to one another, and being rotationally symmetrical around an axis (X) of the assembly forming a seal (1), characterised in that it includes a brush seal (2), which is annular around the axis (X) of the assembly forming a seal (1), having multiple elastic sealing bristles (5, 5a, 5b) intended to be attached to one of the two elements of the turbomachine (10) rotating relative to one another, and at least one lip (3, 3a, 3b, 3c), which is annular around the axis (X) of the assembly forming a seal (1), extending radially in the direction of the brush seal (2), intended to be attached to the other of the two elements of the turbomachine (10) rotating relative to one another, where the said at least one lip (3, 3a, 3b, 3c) penetrates at least partially into the brush seal (2).

### TECHNICAL FIELD

The present invention relates to the field of turbomachines, and more particularly to the general field of sealing devices which enable the flow areas between different cavities of a turbomachine to be reduced. It relates more specifically to an assembly forming a seal for a turbomachine, and also the turbomachine including such an assembly.

The invention applies to all types of land-based or aeronautical turbomachines, and notably to aircraft turbomachines, such as turbojets and turboprop engines. The invention can apply in particular in the field of turbomachines for aircraft, the receiver of which includes a doublet of unshrouded counter-rotating fans; this type of turbomachine is also called an “unshrouded fan turbomachine”, or again an “open rotor” or “propfan” turbomachine. Such a turbomachine can, for example, include a fan attached directly to the power turbine, outside the nacelle, or one driven through a geared power turbine.

### STATE OF THE PRIOR ART

A turbomachine conventionally has a general ventilation circuit. The purpose of the presence of such a general ventilation circuit of the turbomachine engine is to pressurise some chambers of the engine, so as to prevent the ingestion of aerodynamic stream air into cavities which have a maximum acceptable temperature which is less than the temperature of the aerodynamic stream air, or again to prevent oil leaks. Indeed, and in particular in the case of a turbomachines of the “unshrouded fan” type, the covers of the nacelle and the elements which it contains, such as for example the blades' swivel roller bearings, are temperature-sensitive.

Where ingestion of aerodynamic stream air is concerned, the general ventilation circuit provides for installation of sealing devices to reduce the flow areas between different cavities of the turbomachine.

And the efficiency of such sealing devices can vary according to their location in the turbomachines and the turbomachine's overall architecture.

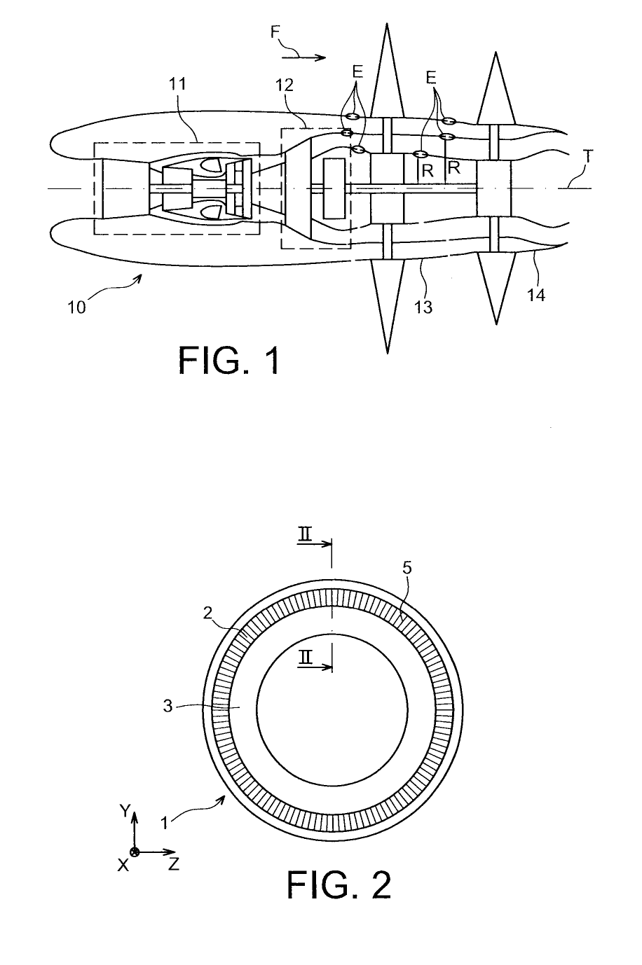

As an example, FIG. 1 represents, schematically, as an axial section, an example of a turbomachine 10 having an overall architecture which can lead to a loss of efficiency of the sealing devices, particularly due to their distant positioning relative to axis of rotation T of turbomachine 10.

Turbomachine 10, which includes a doublet of unshrouded, counter-rotating fans, is of the “open rotor” type. From upstream to downstream it comprises a gas generator 11, a power turbine and gearing 12, and two rotors driving the unshrouded counter-rotating fans, and including respectively rotating nacelles 13 and 14, which must be ventilated and pressurised. As can be seen in FIG. 1, sealing zones E, where the sealing devices must be positioned, are located some way from axis T of turbomachine 10. More specifically, the effect of the particular architecture of turbomachine 10 is to position seals E at large radii R, and it also has the effect of increasing the radial clearances of the seals compared to engines with conventional architecture. In particular, radii R of seals E of such a turbomachine 10 can measure between 300 and 800 mm, whereas they are habitually between several tens of millimetres and approximately 500 mm in a conventional engine.

The increase of radius R of seals E and the increase of radial clearance J of seals E have two consequences for the efficiency of seals E. Indeed, this efficiency is directly related to the flow area of seal E which is expressed as follows:

A=2×π×R×J, where:

A represents the flow area of seal E,

R represents the radius of seal E, and

J represents the radial clearance of seal E.

The increase of radius R of seal E and the increase of radial clearance J of seal E therefore lead to an increase of flow area A of seal E, and therefore to a reduction of the efficiency of seal E.

Generally, in such a case of an engine architecture with a high sealing radius, the sealing devices known in the prior art prove not to be entirely satisfactory to prevent significant loss of efficiency of the seal.

### DESCRIPTION OF THE INVENTION

The aim of the invention is therefore to provide at least a partial solution to the requirements mentioned above, and to the disadvantages compared to the embodiments of the prior art.

In particular, the invention seeks to propose a new solution to produce a seal between two cavities of a turbomachine, in particular in the case of a turbomachine having an architecture with a large seal radius. The invention proposes particularly to maintain a sufficient seal with a high sealing radius, without causing too high a frictional torque, whilst being suitable for high clearances (axial and radial) and high temperatures. The invention also proposes to provide a variable seal solution to adapt to the turbomachine's different operating regimes.

One object of the invention, according to one of its aspects, is thus an assembly forming a seal for a turbomachine, which acts to make the seal between two elements of the rotating turbomachine, relative to one another, in particular between a rotor and a stator of the turbomachine, or between two rotors of the turbomachine, in particular having different speeds of rotation, and being rotationally symmetrical around an axis of the assembly forming a seal, characterised in that it includes:

a brush seal, which is annular around the axis of the assembly forming a seal, having multiple elastic sealing bristles, intended to be attached to one of the two elements of the turbomachine rotating relative to one another,

at least one lip, which is annular around the axis of the assembly forming a seal, extending radially in the direction of the brush seal, intended to be attached to the other of the two elements of the turbomachine rotating relative to one another, where the said at least one lip penetrates at least partially into the brush seal, in particular into the sealing bristles of the brush seal.

By this means, the assembly forming a seal according to the invention allows a brush seal to be associated with at least one annular lip as used in a labyrinth seal.

Seals known as brush seals are for example known in patents U.S. Pat. No. 4,781,388, U.S. Pat. No. 5,480,162 and U.S. Pat. No. 6,170,831. Brush seals consist of multiple bristles or wires, made for example of carbon, which are crimped or bound and held in a housing at one of their ends, and which are in contact, at their free ends, with the surface of the portion of the turbomachine which must be sealed. Such brush seals can allow adjustments in response to the clearance variations to which the sealing devices are subject. Indeed, the bristles of a brush seal can consequently adapt to the deformed or discontinuous surfaces of the portion which must be sealed. Brush seals are used in particular to produce a seal in a high-pressure turbine of a turbomachine, and more particularly at the internal attachment flange of the internal platforms of the guide vanes of the output distributor of the turbomachine's combustion chamber.

The major disadvantage of such brush seals derives from high level of friction they generate when in use.

A labyrinth seal includes a rotating portion with lips (or vanes) with a static bore covered with a soft abradable material, or a honeycomb structure capable of resisting high temperatures. The lips of labyrinths enable aerodynamic seals to be provided between air chambers at different pressures. They are generally located in the rotor portion facing stator portions. They principally consist of annular-shaped continuous or segmented “blades” which can be directed radially internally or externally.

The major disadvantage of such a labyrinth seal results from its having a flow area which is too high to allow satisfactory pressurisation to be achieved.

By virtue of the invention it can be possible to provide a new type of sealing device for a turbomachine, which is particularly suitable for a turbomachine having an architecture with a high sealing radius. The combination of a brush seal with at least one annular lip in the assembly forming a seal according to the invention enables the flow area of the seal to be reduced, and by this means to the efficiency of the seal to be increased compared to the solutions of the prior art. In addition, such an assembly forming a seal according to the invention enables the friction between two elements moving relative to one another to be minimised, and adaptability to the large changes of the radial and axial clearances during different operating phases of the engine.

The assembly forming a seal according to the invention can also include one or more of the following characteristics, considered in isolation or in all possible technical combinations.

The said at least one lip of the assembly forming a seal according to the invention advantageously penetrates at least partially into the brush seal in all configurations of use of the assembly forming a seal, and notably in the nominal position. By this means the efficiency of the seal is increased.

In addition, the assembly forming a seal can be dimensioned so as to optimise its efficiency.

In particular, the total axial thickness of the bristles of the brush seal can be chosen such that they allow constant penetration of the said at least one lip into the brush seal, where this total axial thickness e_{B} of the bristles of the brush seal satisfies the following relationship:

e_{B}≧e_{L}+2·dxₘₐₓ, where:
e_{L} is the total axial thickness of the said at least one lip, and
dxₘₐₓ is the maximum relative axial displacement between the two elements of the turbomachine rotating relative to one another.

The total radial length of the bristles of the brush seal can be chosen to allow sufficient penetration of the said at least one lip into the brush seal, where this total radial length l_{P} of the bristles of the brush seal satisfies the following relationship:

l_{P}≧d+drₘₐₓ, where:
d is the radial distance (or height) between the top of the said at least one lip and the base of the bristles of the brush seal, and
drₘₐₓ is the maximum relative radial displacement between the two elements of the turbomachine rotating relative to one another.

The clearance (or distance) between the base of the said at least one lip and the free ends of the bristles of the brush seal of the assembly forming a seal can advantageously be chosen to prevent any contact between the base of the said at least one lip and the bristles of the brush seal. To accomplish this, such a clearance of the assembly forming a seal can, in particular, be positive or zero in the most closed of configurations, either at the operating point, or when cold. The seal can be provided by a small clearance between the base of the said at least one lip and the free ends of the bristles of the brush seal, or by contact of the flexible bristles of the brush seal on the radial wall of the said at least one lip.

The radial distance between the top of the said at least one lip and the base of the bristles of the brush seal may be chosen to allow the bristles be flexible, enabling the axial movements to be absorbed, where this radial distance d satisfies the following relationship:

d>drₘₐₓ+n·dxₘₐₓ, where:
dxₘₐₓ is the maximum relative axial displacement between the two elements of the turbomachine rotating relative to one another,
drₘₐₓ is the maximum relative radial displacement between the two elements of the turbomachine rotating relative to one another, and
n is a factor, typically equal to 2, which depends on the flexibility of the bristles used.

The radial distance (or clearance) between the free ends of the bristles of the brush seal and the base of the said at least one lip may be chosen to allow the bristles to be flexible, enabling the radial movements to be absorbed, where this radial distance j satisfies the following relationship:

j>drₘₐₓ, where:
drₘₐₓ is the maximum relative radial displacement between the two elements of the turbomachine rotating relative to one another.

The said at least one lip can penetrate at least partially into the brush seal in a zone of the brush seal which has no elastic sealing bristles. In other words, the brush seal may have no elastic sealing bristles opposite the said at least one lip.

The assembly forming a seal may include multiple lips, which are annular around the axis of the assembly forming a seal, which are spaced axially, and which extend radially in the direction of the brush seal, and where the multiple lips penetrate at least partially into the brush seal.

The lips are preferably spaced axially at regular intervals. In addition the lips are preferentially of identical dimensions and shapes.

The bristles of the brush seal can extend towards the interior of the assembly forming a seal according to the invention (i.e. towards the axis of the assembly forming a seal), and the said at least one lip can extend towards the exterior of the assembly forming a seal according to the invention (i.e. at some distance from the axis of the assembly forming a seal). Alternatively, and conversely, the bristles of the brush seal can extend towards the exterior of the assembly forming a seal according to the invention (i.e. at some distance from the axis of the assembly forming a seal), and the said at least one lip can extend towards the interior of the assembly forming a seal according to the invention (i.e. towards the axis of the assembly forming a seal).

Various materials can be used to produce the said at one at least one lip, and the brush seal of the assembly forming a seal according to the invention.

The said at least one lip and/or the brush seal can in particular be made of materials designed to resist temperatures of over 350° C., or of over 600° C., or even of over 900° C. The said at least one lip can, by this means, for example be made of Inconel® and/or titanium. The brush seal can, for example, be made of a ceramic material and/or, preferably, of carbon.

In addition the friction surface for the assembly forming a seal can be the area of contact of only a proportion of the bristles of the brush seal on the wall, advantageously the side wall, of the said at least one lip.

More generally, at least a proportion of the bristles of the brush seal can be able to come into contact with the side wall of the said at least one lip.

The invention can thus, advantageously, enable any contact of the bristles of the brush seal with the top of the said at least one lip, and with the base of the said at least one lip, to be prevented. In particular, all contact with a surface of a cylinder can be prevented. In other words, the said at least one lip can be able to penetrate partially the bristles of the brush seal over a sufficient penetration distance, which is greater than the possible contact between the bristles of the brush seal and the top of the said at least one lip, and less than the possible contact between the bristles of the brush seal and the base of the said at least one lip.

The possibility of contact between at least a proportion of the bristles of the brush seal and the side wall of the said at least one lip can enable different positioning configurations of the brush seal relative to the said at least one lip to be obtained, when the turbomachine is at stop and when the turbomachine is in operation.

In particular, at stop, the said at least one lip can penetrate the bristles of the brush seal without modifying the density of the bristles in the area of the said at least one lip.

Conversely, in operation, the density of the bristles can increase on the side wall of the said at least one lip such that a more powerful seal is produced between the bristles and the said at least one lip, by this means limiting air consumption.

In other words, the pressure of at least a proportion of the bristles of the brush seal against the wall, in particular the side wall, of the said at least one lip, and therefore the associated frictional force, can vary according to the pressure difference between the upstream and the downstream of the brush seal, where this pressure difference depends on whether the turbomachine is at stop or in operation.

This pressure difference between the upstream and downstream of the brush seal can advantageously be small when the turbomachine is at stop, and therefore the frictional force is equally small. Then, when it increases (in operation), and when the density of the bristles increases when the said at least one lip comes into contact with the wall, the seal is increased significantly.

Another object of the invention, according to another of its aspects, is a turbomachine, characterised in that it includes an assembly forming a seal as defined above.

The assembly forming a seal enables the seal to be made between two elements of the turbomachine rotating relative to one another, in particular between a rotor and a stator of the turbomachine, or between two rotors of the turbomachine, in particular having different rotation speeds.

The brush seal can be attached to a rotor of the turbomachine, and the said at least one lip can be attached to a stator of the turbomachine. Conversely, the brush seal can be attached to a stator of the turbomachine, and the said at least one lip can be attached to a rotor of the turbomachine. The brush seal can also be attached to a rotor of the turbomachine, and the said at least one lip can be attached to another rotor of the turbomachine, which notably has a different rotation speed.

The turbomachine can be of the unshrouded fan type (or again “open rotor” type), including a doublet of shrouded counter-rotating fans, located in particular downstream from a combustion chamber of the turbomachine.

The turbomachine can be of the high sealing radius type, including seals located at some distance from the axis of the turbomachine, and in particular located at sealing radii of between 300 and 800 mm relative to the axis of the turbomachine.

### BRIEF DESCRIPTION OF THE ILLUSTRATIONS

The invention can be better understood on reading the detailed description, below, of non-restrictive example implementations of it, and also on examining the figures, which are schematic and partial, of the appended illustration, in which:

FIG. 1 represents, as an axial section, an example of a turbomachine having a particular architecture,

FIG. 2 represents, as a front view, an example of an assembly forming a seal according to the invention,

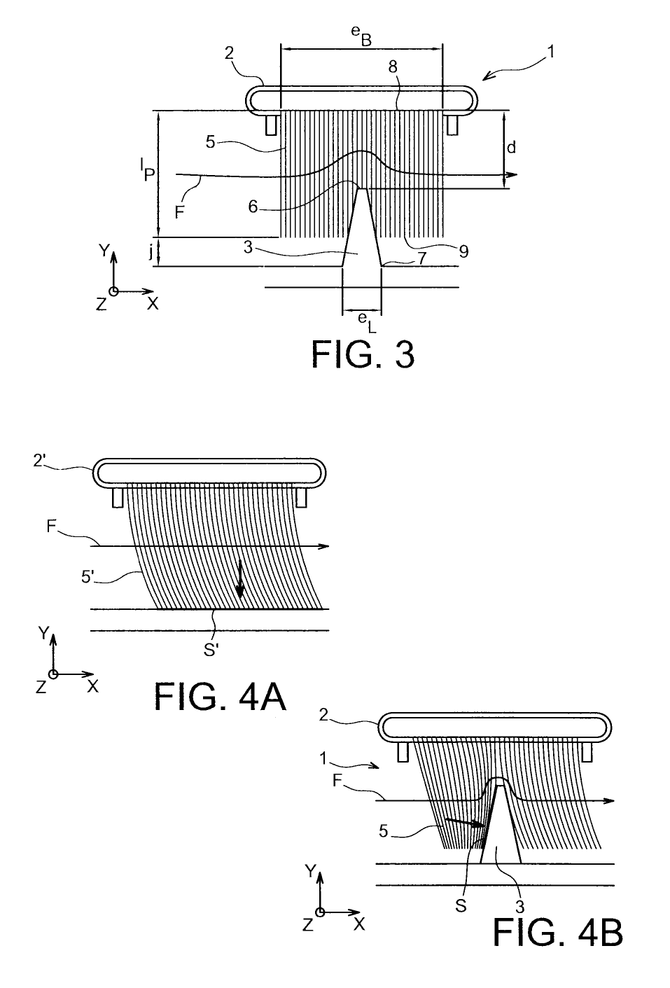

FIG. 3 is a partial view as a cross-section along II-II of the assembly forming a seal of FIG. 2,

FIGS. 4A and 4B illustrate respectively the properties of a brush seal according to the prior art and the properties of an assembly forming a seal according to the invention when an air stream flows,

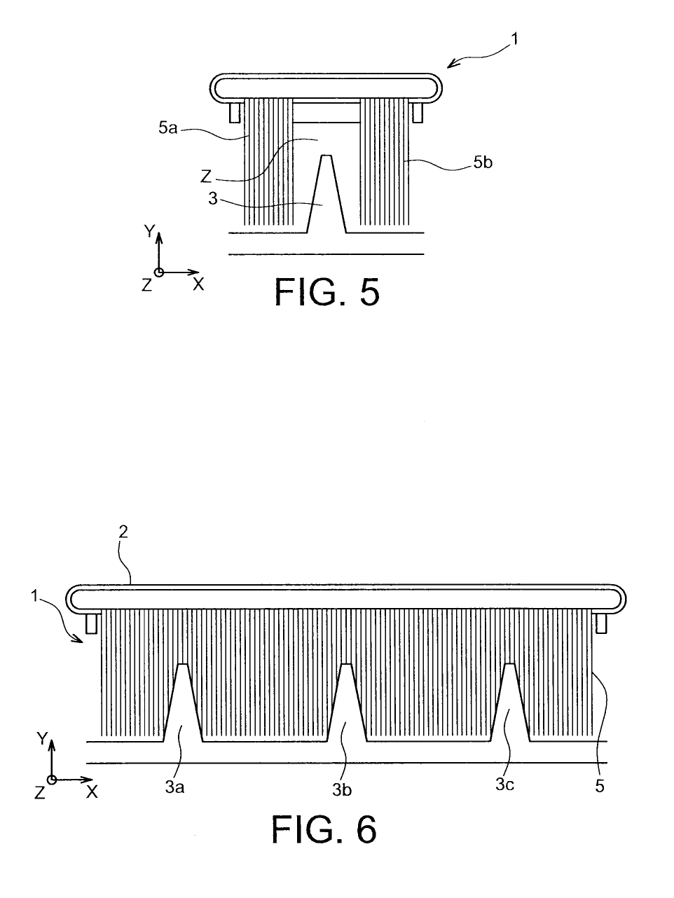

FIGS. 5 and 6 are views similar to that of the assembly forming a seal of FIG. 3, illustrating variant embodiments of the assembly forming a seal according to the invention,

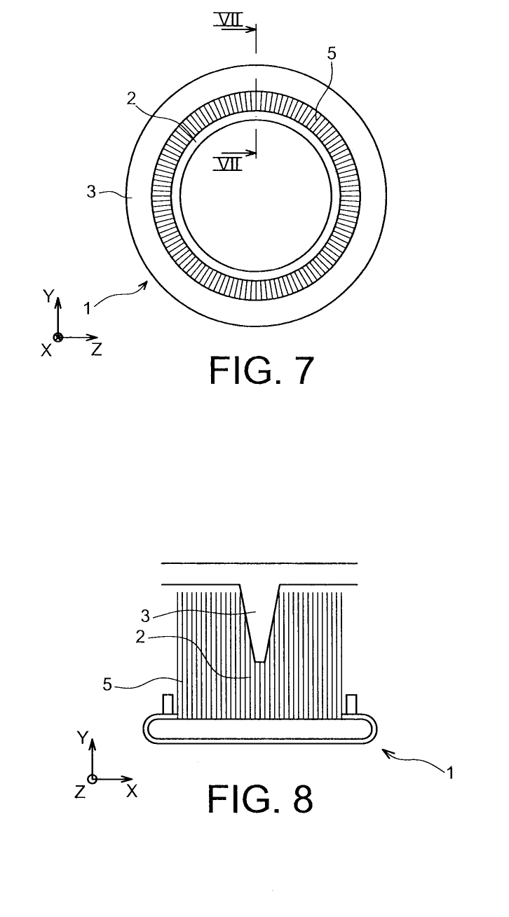

FIG. 7 represents, as a front view, another example of an assembly forming a seal according to the invention, and

FIG. 8 is a partial view as a cross-section along VII-VII of the assembly forming a seal of FIG. 7.

In all these figures, identical references can designate identical or comparable elements.

In addition, the various portions represented in the figures are not necessarily represented at a uniform scale, in order to make the figures more readable.

### DETAILED DESCRIPTION OF PARTICULAR EMBODIMENTS

Throughout the description it is noted that the terms upstream and downstream must be considered relative to a main direction F of normal flow of the gases (from upstream to downstream) for a turbomachine 10. In addition the axis of radial symmetry of turbomachine 10, or the axis of radial symmetry of the assembly forming seal 1, is called axis T of turbomachine 10, or axis X of the assembly forming seal 1. The axial direction of turbomachine 10, or the axial direction of the assembly forming seal 1, is the direction of axis T of turbomachine 10, or the direction of axis X of the assembly forming seal 1. A radial direction of turbomachine 10, or a radial direction of the assembly forming seal 1, is a direction perpendicular to axis T of turbomachine 10, or axis X of the assembly forming seal 1. In addition, unless otherwise stipulated, the adjectives and adverbs “axial”, “radial”, “axially” and “radially” are with reference to the abovementioned axial and radial directions. In addition, unless otherwise stipulated, the terms internal and external are used with reference to a radial direction such that the internal portion of an element is closer to axis T of turbomachine 10, or axis X of the element forming seal 1, than the external portion of the same element.

FIG. 1 has been described previously in the part relative to the state of the prior art.

In FIG. 2 a front view of an example of an assembly forming a seal 1 according to the invention has been represented, and in FIG. 3 a partial cross-section view along II-II of the assembly forming seal 1 of FIG. 2 has been represented.

The assembly forming seal 1 can advantageously be used to provide the seal between two elements of the turbomachine rotating relative to one another, in particular between a rotor and a stator of the turbomachine, or between two rotors of the turbomachine, in particular having different rotation speeds, and in particular to provide one of the seals E of turbomachine 10 represented in FIG. 1.

In accordance with the invention, the assembly forming seal 1 thus includes a brush seal 2 having multiple elastic sealing bristles 5, and a lip 3 extending radially in the direction of brush seal 2 and penetrating at least partially into bristles 5 of brush seal 2.

As can be seen in FIG. 2, brush seal 2 and lip 3 are annular around axis of revolution X of the assembly forming seal 1.

Brush seal 2 and lip 3 can be attached respectively to two rotors of turbomachine 10 having different rotation speeds. As a variant, brush seal 2 can be attached to a rotor of turbomachine 10, and lip 3 can be attached to a stator of turbomachine 10, or vice versa.

By this means, commencing with a seal in the form of a conventional brush seal, invention proposes to add to a rotor or a stator of turbomachine 10 facing brush seal 2 one or more radial lips 3 penetrating into brush seal 2.

Brush seal 2 can be formed in a known manner, in particular including a unit able to be attached to a stator or a rotor of turbomachine 10 and a barrier 5 of bristles held back by the unit.

To obtain the best possible efficiency of the assembly forming seal 1 according to the invention, rules for dimensioning of this seal can be used.

In particular, as can be seen in FIG. 3, total axial thickness e_{B} of bristles 5 of brush seal 2 can be designed to be large enough for lip 3 to remain in brush seal 2 throughout all the relative axial displacements between the rotating elements, relative to one another, of turbomachine 10. This total axial thickness e_{B} of bristles 5 of brush seal 2 can thus satisfy the following relationship: e_{B}≧e_{L}+2×dxₘₐₓ, where e_{L} is the total axial thickness of lip 3 and dxₘₐₓ is the maximum relative axial displacement between the two elements of turbomachine 10 rotating relative to one another having different rotation speeds.

In addition, bristles 5 of brush seal 2 can be designed to be relatively long, in order that they do not rise higher than lip 3, i.e. in order that lip 3 penetrates sufficiently far into brush seal 2. Total radial length lₚ of bristles 5 of brush seal 2 can thus satisfy the following relationship: l_{P}≧d+drₘₐₓ, where d is the radial distance between top 6 of lip 3 and base 8 of bristles 5 of brush seal 2 and drₘₐₓ is the maximum relative radial displacement between two elements of the turbomachine rotating relative to one another.

In addition, clearance j between free ends 9 of bristles 5 and base 7 of lip 3 can be chosen such that it is sufficiently large that there is no contact between bristles 5 and base 7 of lip 3. To obtain this result it is thus desirable to have a clearance j which is either positive or zero at the operating point or, when cold, which is the most closed clearance of the assembly forming seal 1.

In addition, radial clearance (or distance) d between top 6 of lip 3 and base 8 of bristles 5 of brush seal 2 can be designed to be relatively high so as to retain sufficient flexibility of bristles 5 enabling the axial movements to be absorbed. In particular, radial clearance d between top 6 of lip 3 and base 8 of bristles 5 of brush seal 2 can satisfy the following relationship: d>drₘₐₓ+n·dxₘₐₓ, where dxₘₐₓ is the maximum relative axial displacement between two elements of turbomachine 10 rotating relative to one another, drₘₐₓ is the maximum relative radial displacement between the two elements of turbomachine 10 rotating relative to one another, and n is a coefficient, typically equal to 2, which depends on the flexibility of bristles 5 used.

In addition, in order to absorb the radial displacements, radial distance j between base 7 of lip 3 and free ends 9 of bristles 5 of brush seal 2 can also be designed such that they are relatively high, and are thus able to satisfy to the maximum degree possible the following relationship: j>drₘₐₓ, where drₘₐₓ is the maximum relative radial displacement between two elements of turbomachine 10 rotating relative to one another.

d between top 6 of lip 3 and base 8 of bristles 5 of brush seal 2 can also be designed to be relatively long, and thus be able, at minimum, to satisfy the following relationship: d>h_{L}.

The assembly forming seal 1 according to the invention thus enables a solution to be provided enabling a sealing efficiency to be retained between two cavities of turbomachine, and in particular with a turbomachine having an architecture with a high seal radius, such as turbomachine 10 represented in FIG. 1. The assembly forming seal 1 can, indeed, enable a reduction of permeability to be obtained compared to solutions of conventional sealing devices, such as labyrinth seals or brush seals.

FIGS. 4A and 4B illustrate respectively the properties of a brush seal 2′ according to the prior art and the properties of an assembly forming a seal 1 according to the invention when an air stream F flows.

As can be seen by comparing these FIGS. 4A and 4B, the assembly forming seal 1 according to the invention enables the resistive torque to be reduced due to the reduction of the contact surface of bristles 5 on the rotor or stator. Indeed, whereas for a conventional brush seal 2′ friction surface S′ of bristles S′ corresponds to the interference of the free ends of bristles 5′ with the tracks of the rotor or stator, friction surface S for the assembly forming seal 1 according to the invention corresponds to the contact of only a portion of the layer of bristles 5 on the side wall of lip 3. The reduction of the resistive torque between the two configurations of FIGS. 4A and 4B moreover occurs principally when the engine is started. Indeed, at start-up the pressure difference between upstream and downstream of the assembly forming seal 1 according to the invention should generate a lower pressure than the pressure exerted by bristles 5′ on the track of a conventional brush seal 2′. On the contrary, in operation, the assembly forming seal 1 according to the invention should experience an increase of the pressure of bristles 5 on lip 3 (due to the increased pressure difference), whereas the pressure exerted by bristles 5′ on the track of a conventional brush seal 2′ should be reduced (since the airflow has, indeed, a tendency to raise bristles 5′).

In this way, the assembly forming seal 1 according to the invention enables a gain to be obtained in terms of the frictional torque compared to the solutions of the prior art, and this gain depends notably on the area of the layer of bristles 5, the pressure difference in seal E, the speed of relative rotation, and also the characteristics of the materials used.

Whereas in the case of a solution using a conventional brush seal 2′, friction is a constraint which is present from the time of installation, this friction is related to the pressure difference which flattens bristles 5 of brush seal 2 on to lip 3 in the assembly forming seal 1 according to the invention and thus is more like a force resulting from the operation. By this means the assembly forming seal 1 according to the invention can in particular be suitable for small pressure differences.

Furthermore, in comparison with a conventional labyrinth seal, the assembly forming seal 1 according to the invention no longer requires the presence of the abradable material. The abradable material is to some degree replaced by bristles 5 of brush seal 2. The clearance between the lips and the abradable material of a conventional labyrinth seal, which is normally positive (since the lips only penetrate into the abradable with a radial displacement), can on the contrary be considered to be negative between bristles 5 and lip 3 of the assembly forming seal 1 according to the invention.

FIGS. 5 and 6 are views similar to that of the assembly forming seal 1 of FIG. 3, which illustrate variant embodiments of it.

Thus, as can be seen in FIG. 5, lip 3 can penetrate at least partially into brush seal 2, in a zone Z of brush seal 2 which has no elastic sealing bristles.

In other words, the assembly forming seal 1 according to the invention can be produced such that there is no elastic sealing bristle opposite lip 3. Only a first set of bristles 5a and a second set of bristles 5b of brush seal 2 can thus be positioned either side of lip 3.

This variant embodiment can advantageously enable friction to be reduced, better mechanical properties of brush seal 2 to be obtained, by preventing a risk of inversion of the curve of the brush, and can also enable the assembly forming seal 1 to be produced with two separate sets of bristles 5a and 5b, so as to prevent being obliged to produce a very thick single set of bristles 5.

In the variant illustrated in FIG. 6 multiple lips, in particular three lips 3a, 3b, 3c, can be used in the assembly forming seal 1 according to the invention.

The three seals 3a, 3b, 3c can be spaced axially at regular intervals, and extend radially in the direction of brush seal 2, penetrating at least partially into bristles 5 of brush seal 2.

By this means, there can be a redundancy of the lip/bristles combination if, for example, bristles 5 of brush seal 2 deteriorate on one or more lips.

FIG. 7 furthermore represents a front view of another example embodiment of an assembly forming a seal 1 according to the invention, and FIG. 8 is a partial cross-section view along VII-VII of the assembly forming seal 1 of FIG. 7.

In this example embodiment of FIGS. 7 and 8, the relative positioning of brush seal 2 and of lip 3 is reversed compared to the example embodiment illustrated in FIGS. 2 and 3.

More precisely, whereas in FIGS. 2 and 3 bristles 5 of brush seal 2 extend towards the interior of the assembly forming seal 1 (i.e. towards axis X of the assembly forming seal 1, and lip 3 extends towards the exterior of the assembly forming seal 1 (i.e. at some distance from axis X of the assembly forming seal 1), in the example embodiment of FIGS. 7 and 8 bristles 5 of brush seal 2 extend towards the exterior of the assembly forming seal 1 and lip 3 extends towards the interior of the assembly forming seal 1.

The invention is, naturally, not limited to the example embodiments which have just been described. Various modifications may be made to it by those skilled in the art.

The expression “including a” must be understood as being synonymous with “including at least one”, unless the contrary is specified.

1. An assembly forming a seal for a turbomachine, used to form a seal between two elements of the turbomachine rotating relative to one another, and being rotationally symmetrical around an axis of the assembly forming a seal, including:
a brush seal, which is annular around the axis of the assembly forming a seal, having multiple elastic sealing bristles, intended to be attached to one of the two elements of the turbomachine rotating relative to one another other,
at least one lip, which is annular around the axis of the assembly forming a seal, extending radially in the direction of the brush seal, intended to be attached to the other of the two elements of the turbomachine rotating relative to one another, where the said at least one lip penetrates at least partially into the brush seal,
and wherein the total radial length of the bristles of the brush seal is chosen to allow sufficient penetration of the said at least one lip into the brush seal, where this total radial length of the bristles of the brush seal satisfies the following relationship:
l_{P}≧d+drₘₐₓ, where:
d is the radial distance between the top of the said at least one lip and the base of the bristles of the brush seal, and
drₘₐₓ is the maximum relative radial displacement between the two elements of the turbomachine (10) rotating relative to one another.

2. An assembly according to claim 1, wherein the total axial thickness of the bristles of the brush seal is chosen to allow a constant penetration of the said at least one lip into the brush seal, where this total axial thickness of the bristles of the brush seal satisfies the following relationship:
e_{B}≧e_{L}+2·dxₘₐₓ, where:
e_{L} is the total axial thickness of the said at least one lip, and
dxₘₐₓ is the maximum relative axial displacement between the two elements of the turbomachine rotating relative to one another.

3. An assembly according to claim 1, wherein the radial distance between the top of the said at least one lip and the base of the bristles of the brush seal is chosen to allow a flexibility of the bristles enabling the axial movements to be absorbed, where this radial distance (d) satisfies the following relationship:
d>drₘₐₓ+n·dxₘₐₓ, where:
dxₘₐₓ is the maximum relative axial displacement between the two elements of the turbomachine rotating relative to one another,
drₘₐₓ is the maximum relative radial displacement between the two elements of the turbomachine rotating relative to one another, and
n is a factor which depends on the flexibility of the bristles used.

4. An assembly according to claim 1, wherein the radial distance between the free ends of the bristles of the brush seal and the base of the said at least one lip is chosen to allow a flexibility of the bristles enabling the radial movements to be absorbed, where this radial distance satisfies the following relationship:
j>drₘₐₓ, where:
drₘₐₓ is the maximum relative radial displacement between the two elements of the turbomachine (10) rotating relative to one another.

5. An assembly according to claim 1, wherein the said at least one lip penetrates at least partially into the brush seal, in an area of the brush seal having no elastic sealing bristles.

6. An assembly according to claim 1, wherein it includes multiple lips, which are annular around the axis of the assembly forming a seal, spaced axially and extending radially in the direction of the brush seal, where the multiple lips penetrate at least partially into the brush seal.

7. An assembly according to claim 1, wherein the friction surface for the assembly forming a seal corresponds to the contact of only a proportion of the bristles of the brush seal on the wall of the said at least one lip.

8. An assembly according to claim 1, wherein at least a proportion of the bristles of the brush seal is able to come into contact with the side wall of the said at least one lip.

9. A turbomachine, wherein including an assembly forming a seal according to claim 1.

10. A turbomachine according to claim 9, wherein it is of the unshrouded fan type, including a doublet of unshrouded counter-rotating fans.

11. A turbomachine according to claim 9, wherein it is of the high sealing radius type, including seals located at some distance from the axis of the turbomachine, and located at sealing radii of between 300 and 800 mm relative to the axis of the turbomachine.
